(19) United States
(12) Patent Application Publication
(10) Pub. No.: US 2013/0191789 A1
(43) Pub. Date: Jul. 25, 2013

(54) CONTROLLING A TRANSACTION WITH COMMAND GESTURES

(71) Applicants: MATTHEW A. CALMAN, Charlotte, NC (US); SUSAN SMITH THOMAS, Gastonia, NC (US); ERIK STEPHEN ROSS, Charlotte, NC (US); JOOYONG LEE, Silver Spring, MD (US); ZHENSHUO FANG, San Francisco, CA (US); JAMES MULHOLLAND, San Francisco, CA (US); BRENDAN KIU, Sunnyvale, CA (US); NASTASHA TAN, Torrance, CA (US)

(72) Inventors: MATTHEW A. CALMAN, Charlotte, NC (US); SUSAN SMITH THOMAS, Gastonia, NC (US); ERIK STEPHEN ROSS, Charlotte, NC (US); JOOYONG LEE, Silver Spring, MD (US); ZHENSHUO FANG, San Francisco, CA (US); JAMES MULHOLLAND, San Francisco, CA (US); BRENDAN KIU, Sunnyvale, CA (US); NASTASHA TAN, Torrance, CA (US)

(73) Assignee: BANK OF AMERICA CORPORATION, Charlotte, NC (US)

(21) Appl. No.: 13/355,919

(22) Filed: Jan. 23, 2012

(51) Int. Cl. G06F 3/033

(52) U.S. Cl. 715/863

(57) ABSTRACT

Embodiments of the invention include systems, methods, and computer-program products that provide for a unique system for controlling transactions based on command gestures. In one embodiment of the invention, a computer-implemented method determines that a user is conducting a transaction with a mobile device. The mobile device senses a gesture performed by the user with the mobile device and alters at least one aspect of the transaction based on the gesture. The gestures can control a wide variety of aspects of the transaction. For example, the user may flag an item for review during the transaction, silence the transaction, receive a subtotal for the transaction, select a payment method, or complete the transaction. In an embodiment, the user is able to customize the gestures to control the transaction according to the user's preferences.

### BACKGROUND

Currently, individuals conduct transactions using credit cards, debit cards, cash, or checks. Individuals typically observe the transaction and verbally instruct a person on the other side of the transaction to control the transaction. Not everyone, however, feels comfortable verbally instructing the person operating the cash register. For example, some individuals may not speak the language in which the transaction is being conducted. The individual may still desire to conduct a transaction but without the difficulties of stumbling through an unfamiliar language.

Other individuals may not be able to observe the transaction. For example, visually impaired individuals may be unable to observe the items being scanned during a transaction. Without being able to see the item, visually impaired individuals may be unable to determine that the item being scanned is the item that was intended to be purchased. Further, because transaction devices, e.g., cash registers, are not uniform across different stores and different transactions, visually impaired individuals are limited in their ability to apply knowledge of one transaction device to another transaction device, or in some instances even locate the transaction device at the point-of-transaction location.

Financial institutions look to serve both customers and business clients. For example, financial institutions look to provide customized transaction experiences so that all of its customers are able to conduct transactions and businesses are able to provide secure and effective access to all customers.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

In an embodiment, a computer-implemented method for controlling a transaction based on command gestures is provided, wherein the method includes determining, via a computing device processor, that a user is conducting a transaction using a mobile device. The computer-implemented method senses, via a computing device processor, at least one command gesture performed by the user with the mobile device. In an embodiment, sensing the at least one command gesture comprises sensing the command gesture using a positioning system device associated with the mobile device, wherein the positioning system device is configured to sense movement of the mobile device. The mobile device may sense the command gesture using positioning system devices associated with the mobile device, such as accelerometers, GPS receivers, magnetometers, altimeters, compasses, Wi-Fi receivers, etc. After sensing the command gesture, the computer-implemented method alters at least one aspect of the transaction based on the command gesture.

In various embodiments, the command gestures include gestures that silence the mobile device and/or point-of-transaction device, gestures that allow the user to flag products for further questions and/or transmitting the flag to the point-of-transaction device, gestures that allow the user to receive a subtotal, gestures that allow the user to switch between payment methods, and gestures that complete the transaction, etc. A personal identification number may also be entered to initiate completion of the transaction. In a further embodiment, the computer-implemented method causes the mobile device and/or the point-of-transaction device to audibly report the products and/or prices of the items purchased in the transaction. Similarly, initiation or completion of the transaction can be audibly reported. In some embodiments, the transaction is altered by entering a payment mode based on a command gesture.

In a further embodiment, the computer-implemented method further comprises storing one or more reference gestures in a storage device, wherein each gesture is associated with a function to be performed as an aspect of the transaction; and comparing a sensed command gesture to the one or more reference gestures in the storage device to determine the aspect of the transaction to be altered. In an embodiment, the command gestures are customizable. In still further embodiments, the method comprises pairing the mobile device to the point-of-transaction device, such as by providing a code on the mobile device that is scannable by the point-of-transaction device.

In a further embodiment, a device for controlling a transaction based on command gestures is provided. In some embodiments, the device comprises a mobile device and a computing platform including a processor and a memory, wherein the computing platform is operably linked to the mobile device. The device includes a transaction identification routine stored in the memory, executable by the processor, and configured to determine that a user is conducting a transaction using a mobile device. The device may also include a sensing routine stored in the memory, executable by the processor, and configured to sense at least one command gesture performed by the user with the mobile device. Further, the device may include a transaction routine stored in the memory, executable by the processor, and configured to alter at least one aspect of the transaction based on the command gesture. In some embodiments, the mobile device includes a positioning system device, such as an accelerometer, GPS receiver, magnetometer, Wi-Fi receiver, compass, or altimeter, etc., configured to determine the orientation of the mobile device and provide the orientation to the processor. In an embodiment, the device also includes a notification routine stored in the memory, executable by the processor, and configured to notify the user during the transaction. Similarly, in some embodiments, the device includes a completion routine stored in the memory, executable by the processor, and configured to complete the transaction after receiving a command gesture from the user. In further embodiments, the device also includes a communication device configured to communicate with the point-of-transaction device. For example, the communication device may communicate with the point-of-transaction device over a wireless, secure network. In yet still further embodiments, the device includes an activation device, such as a keychain dongle, that activates the device when the user contacts the activation device to the mobile device.

In another embodiment, a computer program product for controlling a transaction based on command gestures is provided. The computer program product comprises a computer-readable medium comprising a first set of codes for causing a computer to determine that a user is conducting a transaction using a mobile device, a second set of codes for causing a computer to sense at least one command gesture performed by the user with the mobile device, and a third set of codes for causing a computer to alter at least one aspect of the transaction based on the command gesture. In an embodiment, the first set of codes determines that the user is conducting a transaction based on a command gesture. In some embodiments, the second set of codes senses the at least one command gesture using a positioning system device. In further embodiments, the third set of codes alters the at least one aspect of the transaction by sensing the command gesture and comparing the sensed command gesture to a database comprising a plurality of command gestures and associated transaction commands. In some embodiments, the computer program product further comprises a set of codes for causing a computer to receive a pre-defined list for the transaction, and a set of codes for causing a computer to compare the pre-defined list to the transaction. The computer program product is able to provide a subtotal for the transaction by the user shaking the mobile device; is able to silence the transaction by the user turning the mobile device over; and is able to flag an item during the transaction by laterally tapping the mobile device.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for controlling transactions with command gestures, in accordance with some embodiments of the invention;

FIG. 2 is a depiction of an environment in which a user controls a transaction with command gestures, in accordance with some embodiments of the invention;

FIG. 3 is a block diagram illustrating a mobile device, in accordance with an embodiment of the invention;

FIG. 4 is a block diagram of a financial institution's banking system, in accordance with some embodiments of the invention;

FIGS. 5A and 5B are flow charts of a computer-implemented method for controlling a transaction with command gestures, in accordance with some embodiments of the invention; and

FIG. 6 is an example of activating the mobile device using an activation device, in accordance with an embodiment of the invention.

FIG. 7 is an example of pairing the mobile device to the point-of-transaction device, in accordance with an embodiment of the invention.

FIG. 8 is an example of a command gesture for changing the payment method, in accordance with an embodiment of the invention.

FIG. 9 is an example of a command gesture for selecting a specific payment method, in accordance with an embodiment of the invention.

FIG. 10 is an example of a command gesture for requesting a subtotal for a transaction, in accordance with an embodiment of the invention.

FIG. 11 is an example of a mobile device displaying products purchased using command gestures, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Computer-implemented methods, systems, apparatuses, and computer program products are described herein for providing a method that allows a user to control a transaction using gestures. In some embodiments, the method is configured to assist visually-impaired individuals conduct transactions without requiring visual confirmation of products and/or transaction hardware. In an embodiment, a computer-implemented method for controlling a transaction based on command gestures is provided, wherein the method includes determining, via a computing device processor, that a user is conducting a transaction using a mobile device. The computer-implemented method senses, via a computing device processor, at least one command gesture performed by the user with the mobile device. After sensing the at least one command gesture, the computer-implemented method alters at least one aspect of the transaction based on the command gesture. In various embodiments, the command gestures include gestures that silence the mobile device and/or point-of-transaction device, gestures that allow the user to flag products for further questions, gestures that allow the user to receive a subtotal, gestures that allow the user to switch between payment methods, and gestures that complete the transaction, etc. Through the use of gestures, the user is able to conduct the transaction securely without transferring information to another individual. In a further embodiment, the computer-implemented method causes the mobile device and/or the point-of-transaction device to audibly report the products and/or prices of the items purchased in the transaction. Visually-impaired individuals can receive audible confirmation of the products being purchased and their prices. The computer-implemented method provides flexible control over transactions with intuitive and in some cases customized gestures.

Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In another embodiment, a transaction is an interaction between the user and an object, wherein the identity of the user is authenticated. In one embodiment, the identity of the user is authenticated by means of a signature move of the user. In some embodiments, the signature move is a command gesture created or selected by the user that authenticates the identity of the user. The signature move may replace identity confirmation, such as by use of a photo ID. In some embodiments, the signature move allows the user to interact with objects after authentication. For example, an automobile or home may unlock after authentication with a signature move. If the user is conducting a transaction through an application on a mobile device, such as purchasing stocks or transferring money between accounts, the user may authorize the transaction by making the signature move. In some embodiments, authentication of the user's identity is desired in health care situations. For example, the user may desire access to health care records or be purchasing prescription medicines. By making the user's signature move, the user may gain access to the health care records or be authorized to purchase the prescription medicines. It should be understood that the signature move can allow the user to interact with other types of objects as well. For example, the signature move can sign the user into a computer or log the user into a webpage.

The point-of-transaction device is a device that facilitates the transaction between the user and the business or organization. In an embodiment, the point-of-transaction device is a cash register at a store. A point-of-transaction device can be another mobile device configured for transactional functionality. In some embodiments, the point-of-transaction device is associated with commerce but does not indicate that the user is making a purchase. For example, the user may be having a credit check run. Automated teller machines (ATMs) are also considered point-of-transaction devices that may be controlled by command gestures. In further embodiments, the point-of-transaction device is the object to which the user is authenticating the user's identity.

As will be discussed, a “mobile device” may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. In an embodiment, the mobile device includes sensing technology to determine the orientation and movement of the device. The movement of the mobile device by the user comprises a gesture. In an embodiment, many different types of gestures can be used as a command gesture during a transaction. For example, shaking, turning, moving quickly, touching, or gesturing in predetermined directions (e.g., revolving in a circle) can be used to control transactions based on the command gestures.

In another embodiment, the mobile device detects a command gesture based on a biometric scan of the user. For example, the mobile device may capture a video of the user's face and identify a command gesture based on iris recognition or facial recognition. In one embodiment, the command gesture is lifting the mobile device and activating the camera so that the iris scan or facial scan can take place. In another example, the biometric scan is a fingerprint scan captured on a screen of the mobile device. Other biometric scans, such as DNA fingerprinting or voice recognition, can also serve as command gestures.

In a still further embodiment, the mobile device detects a command gesture made by the user. For example, the mobile device may capture a live video of the user making a gesture with a hand, an arm, or another portion of the user's body (e.g., a wink, etc.). In this manner, the user captures the command gesture with the mobile device but does not use the mobile device to make the command gesture. In another embodiment, the mobile device creates a field and then detects a command gesture made by the user in the field. For example, the mobile device may create a radio frequency (RF) field in the vicinity of the mobile device. The user disturbs the RF field by making a movement through the field and thereby performs a command gesture. Similarly, the mobile device may create a magnetic field, electric field, Near Field Communication (NFC) field, or other type of field in the vicinity of the mobile device. The mobile device then detects disturbances in the field and determines a command gesture based on the disturbance. For example, the mobile device may emit a magnetic field above the device. As the user swipes his hand through the air above the mobile device, the magnetic field is disturbed, such as by a ring the user is wearing. The mobile device detects this change in the magnetic field, determines that it is caused by a hand being swiped from left to right above the mobile device, and looks up this command gesture in a database to determine that the user intends to change payment methods. It should be understood that other types of fields and other means of evaluating changes in the field are possible.

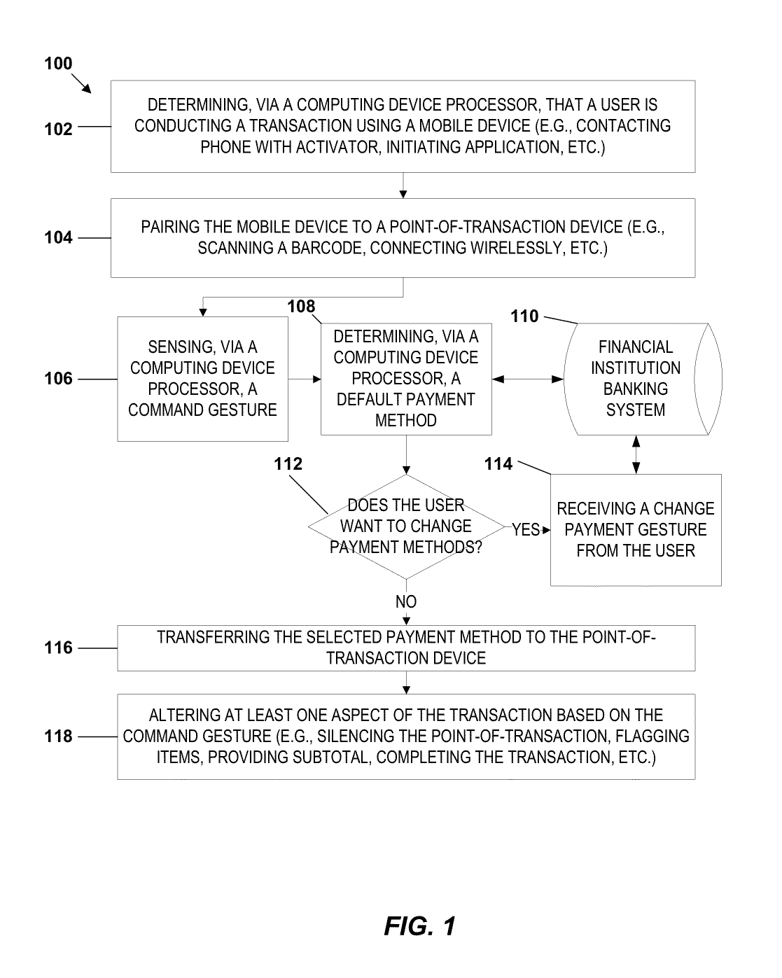

Determination of gestures, the effects of gestures, and customization procedures using the computer-implemented method are discussed in more depth below with regard to FIGS. 1-11. The transactions at the point-of-transaction device will generally be discussed with regard to purchases though it should be understood that other types of transactions are possible. For example, returns, credit checks, balance inquiries (e.g., at an ATM, etc.), and transfers may all be controlled based on command gestures in the computer-implemented method.

As illustrated in FIGS. 1-11, aspects of the present disclosure include computer-implemented methods, systems, and computer program products for allowing users to control transactions using gestures. It will be appreciated that, although embodiments of the present invention are generally described in the context of using mobile phones, other embodiments of the invention provide for different types of mobile devices, such as bracelets, tablet computers, hardware dongles, etc., that can be used to control transactions using gestures.

FIG. 1 illustrates a general process flow of a computer-implemented method 100 for controlling a transaction based on command gestures, in accordance with an embodiment of the invention. In block 102, the computer-implemented method 100 determines, via a computing device processor, that a user is conducting a transaction using a mobile device. For example, the user may be conducting a transaction using a mobile wallet application on the mobile device. As will be discussed, the computer-implemented method 100 can determine that a user is conducting a transaction in a variety of ways. In one embodiment, the user makes a command gesture that indicates that the user is conducting a transaction. In another embodiment, the user activates an application, such as by pressing a button or contacting an activation device to the mobile device. For example, the user may include an activation device on a key chain and when the user desires to conduct the transaction, the user contacts the activation device to the mobile device. In other embodiments, the computer-implemented method 100 determines that the user is conducting a transaction using a mobile device based on communication from a point-of-transaction device. For example, the user may sync the mobile device with the point-of-transaction device, which then communicates with a server that the user is conducting a transaction.

In block 104, the computer-implemented method 100 pairs the mobile device to a point-of-transaction device. In some embodiments, pairing the mobile device to the point-of-transaction device identifies the mobile device, authenticates the mobile device, and/or syncs the mobile device to allow communication. In an exemplary embodiment, the mobile device displays a barcode on a display screen. The point-of-transaction device scans the barcode and the mobile device and point-of-transaction device are paired. In some embodiments, the mobile device and the point-of-transaction device are paired wirelessly, for example, via Wi-Fi, Near Field Communication devices, or other wireless transmitters. In an embodiment, pairing is accomplished or triggered by a user gesture. For example, the user can move the mobile device towards the point-of-transaction device or tap the point-of-transaction device with the mobile device. In another embodiment, the pairing provides a secure connection, e.g., encrypted, for transmission of financial account data.

In block 106, in some embodiments the computer-implemented method 100 senses, via a computing device processor, a gesture performed by the user with the mobile device. In some embodiments, the command gesture is sensed by a positioning system device, such as an accelerometer. The user manipulates the mobile device to perform a gesture that is sensed by the positioning system device and identified by a processor associated with the mobile device. In an embodiment, a command gesture database is evaluated to compare the identified gesture with reference gestures that have already been associated with actions relating to the transaction. For example, the action may change an aspect of the transaction, such as the payment method, whether the audible notifications of steps in the transaction are provided, or the current subtotal for the transaction. In further embodiments, the command gestures are defined so that users do not unintentionally activate the computer-implemented method, for example by accidentally moving the mobile device. Thus, in some embodiments, the command gesture is a non-standard gesture that the user completes with the mobile device to activate the computer-implemented method. The user may move the mobile device in a circle, a figure-eight, or some other gesture that is not a common movement for the mobile device. In still further embodiments, the command gesture can be customized for and/or by the user based on choice and capabilities.

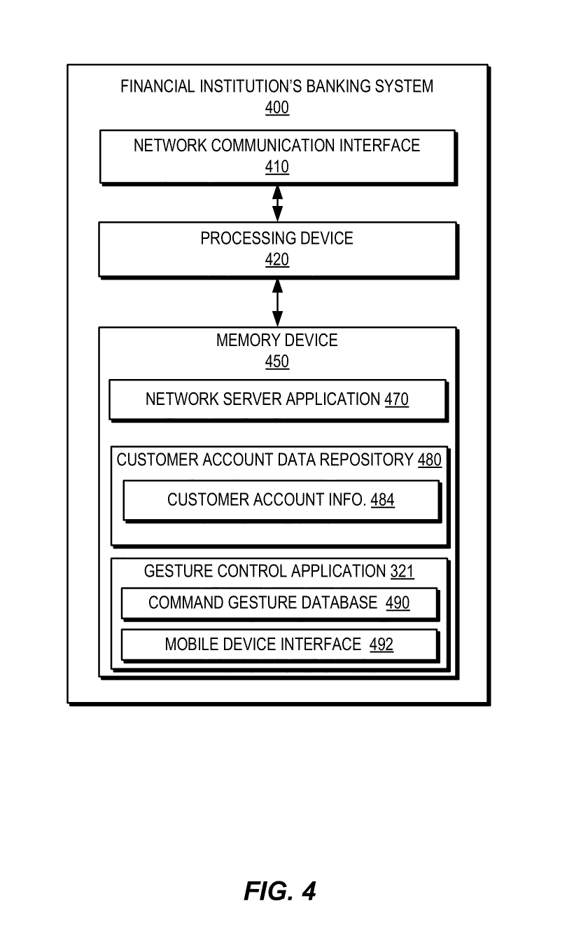

Turning now to block 108, the computer-implemented method 100 determines, via a computing device processor, a default payment method. The default payment method may be preset by the financial institution or by the user. In an embodiment, the computer-implemented method 100 determines the default payment method in coordination with the financial institution banking system, as depicted on block 110. The financial institution banking system will be discussed in greater detail in FIG. 4. Any type of payment method may be used to conduct the transaction, such as a credit card, a debit card, a checking account, a savings account, a reward points account, etc. Different default payment methods can be selected based on characteristics of the transaction, such as the time, location, or amount of the transaction. For example, transactions totaling less than $10.00 can have one default payment method, e.g., a checking account, while transactions totaling more than or equal to $10.00 can have a second default payment method, e.g., a credit card. In an embodiment, the computer-implemented method 100 notifies the user of the default payment method, such as by audibly notifying the user or by displaying the default payment method on a screen.

In block 112, the computer-implemented method 100 determines whether the user wants to change payment methods. If the user does not want to change payment methods, the computer-implemented method proceeds to block 116, where the computer-implemented method transfers the selected payment method to the point-of-transaction device. If the user wants to change payments, however, the computer-implemented method receives a change payment gesture from the user, as shown in block 114. The computer-implemented method may automatically allow the user to select a different payment method. For example, after pairing and/or initiating the transaction with the mobile device, a specific gesture may automatically change the payment method. In an exemplary embodiment, swiping a finger from one side of the screen to another side of the screen can change the method of payment. Multiple swipes can cycle through the various payment options available to the user. In some embodiments, the computer-implemented method notifies the user of the currently selected payment method, such as by an audible notification. In an embodiment, the user predefines the various methods of payment that can be used with the computer-implemented method. For example, the user can select all of the user's accounts or a subset of the user's accounts to use with the computer-implemented method. Once the user selects the desired payment method, the computer-implemented method transfers the selected payment method information to the point-of-transaction device, as shown in block 116.

Turning now to block 116, the computer-implemented method 100 transmits the selected payment method to the point-of-transaction device. In some embodiments, the mobile device transmits the payment method to the point-of-transaction device wirelessly. For example, the mobile device may transmit the payment method information via Wi-Fi or NFC. In an embodiment, the transmission is encrypted for security.

In block 118, the computer-implemented method 100 alters at least one aspect of the transaction based on the command gesture. As will be discussed in greater detail, a wide variety of command gestures can be used to alter aspects of the transaction. User manipulation of the mobile device can include changing the orientation of the device, moving the device, tapping on or causing the device to vibrate, movement of the device in specific shapes, capturing command gestures using cameras, sensing field disturbances, etc. In one embodiment, various gestures have default effects, such as silencing the mobile device, requesting a subtotal for the transaction, or flagging a product for later questions. In another embodiment, users can customize gestures so that the meaning of a gesture differs from the default meaning Customization may be desired if users have mobility issues, such as the inability to move a mobile device in a specific shape, or if the users merely wish to request easily-remembered gestures for certain commands. Aspects of the transaction can be altered in various ways as well. For example, a transaction can be completed, a membership number can be provided, a coupon can be applied, an item can be removed from an order, an item can be flagged, etc. While various actions are described herein, the list of actions is merely exemplary. Given the disclosure herein, one skilled in the art would be able to define additional actions that can be controlled with command gestures using the computer-implemented method.

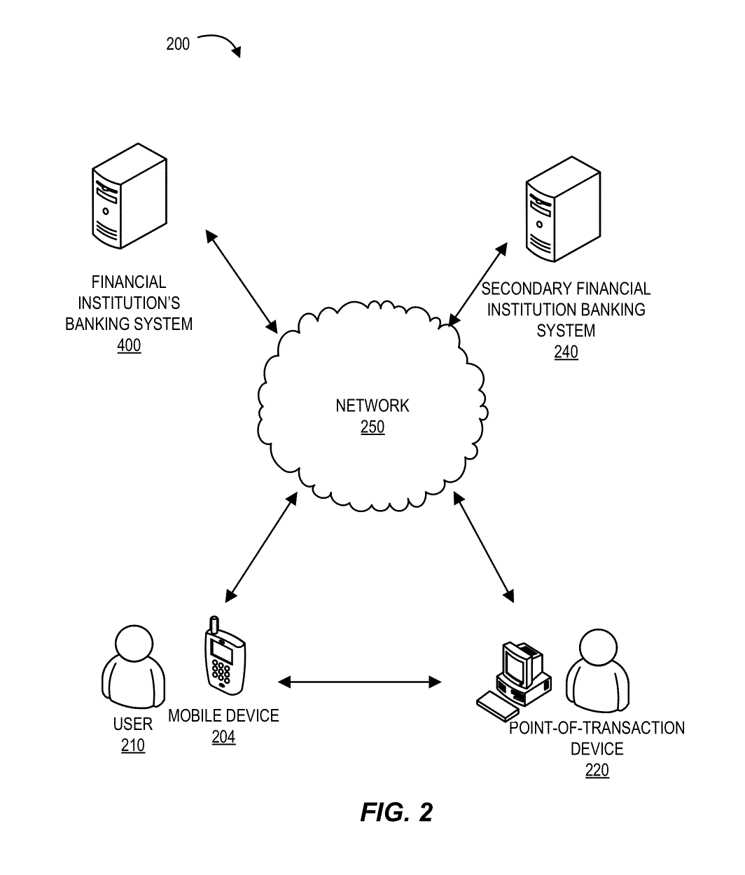

Referring to FIG. 2, a block diagram illustrating an environment 200 in which a user 210 controls a transaction based on command gestures is provided in accordance with an embodiment of the invention. The computer-implemented method determines that the user 210 is conducting a transaction and, in some embodiments, the mobile device 204 is paired to the point-of-transaction device 220, such as a cash register at a business. In an embodiment, the point-of-transaction device 220 or the user's mobile device 204 transmits the data over a network 250. For example, the data may be transmitted over wired networks, wireless networks, the Internet, Near Field Communication (NFC) networks, Bluetooth™ networks, or the like.

In some embodiments, the data transmit over the network 250 to the financial institution's banking system 400, where the financial account information for the user 210 is determined. In some embodiments, the user 210 is identified in coordination with other financial institution banking systems 240, with the user 210 or the user's mobile device 204, or with the point-of-transaction device 220. For example, the computer-implemented method may determine that the user is attempting to conduct a transaction using an account hosted by a secondary financial institution, i.e., a financial institution not affiliated with the computer-implemented method. In another embodiment, the mobile device 204 and the point-of-transaction device 220 communicate directly without communicating with the financial institution. For example, the mobile device 204 may include the user's financial account information in the memory of the device.

In some embodiments, the financial institution's banking system 400 cooperates with the mobile device 204 to determine the command gesture and control the transaction. For example, the mobile device 204 may determine the command gesture but the banking system 400 may determine the meaning of the gesture with respect to the transaction.

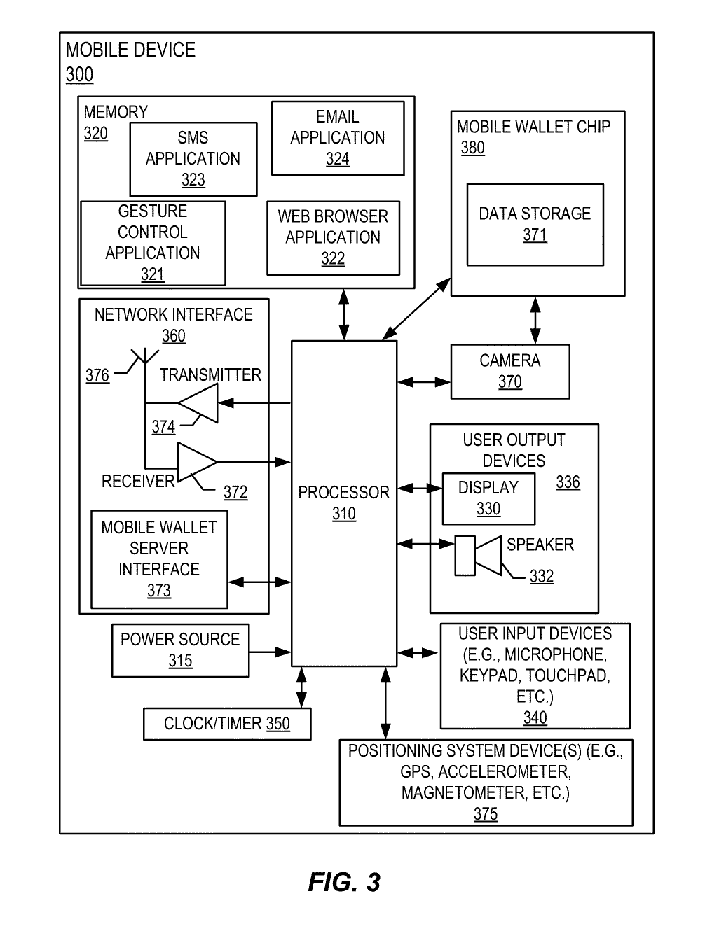

FIG. 3 illustrates an embodiment of a mobile device 300 that may be configured to allow users to control a transaction with command gestures. A “mobile device” 300 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. In some embodiments, the mobile device 300 includes a wired or wireless connection to a communication device, such as an earpiece, stereo headset, or other communication device, wherein the communication device is configured to relay transaction information to the user. In a further embodiment, activation technology for the mobile device is embedded in a keychain, chip, bracelet, or other device that can be conveniently carried by the user but is separate from the mobile device.

The mobile device 300 may generally include a processor 310 communicably coupled to such components as a memory 320, user output devices 336, user input devices 340, a network interface 360, a power source 315, a clock or other timer 350, a camera 370, at least one positioning system device 375, one or more mobile wallet chips 380, etc. The processor 310, and other processors described herein, may generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The positioning system device 375 is configured to determine the orientation and velocity of the mobile device. For example, the positioning system device can be an accelerometer configured to determine the orientation and movement of the device. Similarly, the positioning system device 375 can be a magnetometer configured to determine the movement of the mobile device. In other embodiments, the positioning system device is a level to determine orientation of the device; a compass to determine direction independent of the device; or an altimeter configured to determine the elevation of the device. Other types of positioning system devices 375 are possible and are configured to determine the orientation of the mobile device as the command gestures to control transactions.

The processor 310 may also be capable of operating applications, such as a gesture control application 321. The gesture control application 321 may be downloaded from a server and stored in the memory 320 of the mobile device 300. Alternatively, the gesture control application 321 may be pre-installed and stored in a memory in the mobile wallet chip 380 or operated directly from a website operably linked to the mobile device 300 through the network interface 360. In embodiments, where the gesture control application 321 is pre-installed or run from a website, the user may not need to download the gesture control application 321 from a server.

The mobile wallet chip 380 may include the necessary circuitry to provide the gesture control and transaction completion functionality to the mobile device 300. Generally, the mobile wallet chip 380 will include data storage 371 which may include data associated with the financial accounts of the user, default settings, or other information for controlling transactions using gestures. The mobile wallet chip 380 and/or data storage 371 may be an integrated circuit, a microprocessor, a system-on-a-chip, a microcontroller, or the like. As discussed above, in one embodiment, the mobile wallet chip 380 provides the gesture control functionality to the mobile device 300.

Of note, while FIG. 3 illustrates the mobile wallet chip 380 as a separate and distinct element within the mobile device 300, it will be apparent to those skilled in the art that the mobile wallet chip 380 functionality may be incorporated within other elements in the mobile device 300. For instance, the functionality of the mobile wallet chip 380 may be incorporated within the mobile device memory 320 and/or the processor 310. In a particular embodiment, the functionality of the mobile wallet chip 380 is incorporated in an element within the mobile device 300 that provides transaction completion capabilities to the mobile device 300. Moreover, the functionality may be part of the firmware of the mobile device 300. In some embodiments, the functionality is part of an application downloaded and installed on the mobile device 300. Still further, the mobile wallet chip 380 functionality may be included in a removable storage device such as an SD card or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include a mobile wallet server interface 373 in order to allow a user to execute some or all of the above-described processes with respect to the gesture control application 321 and/or the mobile wallet chip 380. The mobile wallet server interface 373 may have access to the hardware, e.g., the transceiver, and software previously described with respect to the network interface 360. Furthermore, the mobile wallet server interface 373 may have the ability to connect to and communicate with an external data storage on a separate system within the network, such as a server in the financial institution.

As described above, the mobile device 300 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. The user input devices 340, which may allow the mobile device 300 to receive data from a user 210, may include any of a number of devices allowing the mobile device 300 to receive data from a user 210, such as a keypad, keyboard, touch-screen, touchpad, microphone, mouse, joystick, stylus, other pointer device, button, soft key, and/or other input device(s).

The mobile device 300 may further include a power source 315. Generally, the power source 315 is a device that supplies electrical energy to an electrical load. In one embodiment, power source 315 may convert a form of energy such as solar energy, chemical energy, mechanical energy, etc. to electrical energy. Generally, the power source 315 in the mobile device 300 may be a battery, such as a lithium battery, a nickel-metal hydride battery, or the like, that is used for powering various circuits, e.g., the transceiver circuit, and other devices that are used to operate the mobile device 300. Alternatively, the power source 315 may be a power adapter that can connect a power supply from a power outlet to the mobile device 300. In such embodiments, a power adapter may be classified as a power source “in” the mobile device.

The mobile device 300 may also include a memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs which comprise computer-executable instructions/code executed by the processor 310 to implement the functions of the mobile device 300 described herein. For example, the memory 320 may include such applications as a gesture control application 321, a web browser application 322, an SMS application 323, an email application 324, etc.

FIG. 4 provides a block diagram illustrating the banking system 400 in greater detail, in accordance with embodiments of the invention. As illustrated in FIG. 4, in one embodiment of the invention, the banking system 400 includes a processing device 420 operatively coupled to a network communication interface 410 and a memory device 450. In certain embodiments, the banking system 400 is operated by a first entity, such as a financial institution, while in other embodiments the banking system 400 is operated by an entity other than a financial institution.

It should be understood that the memory device 450 may include one or more databases or other data structures/repositories. The memory device 450 also includes computer-executable program code that instructs the processing device 420 to operate the network communication interface 410 to perform certain communication functions of the banking system 400 described herein. For example, in one embodiment of the banking system 400, the memory device 450 includes, but is not limited to, a network server application 470, a user account data repository 480, which includes user account information 484, a gesture control application 321, which includes a command gesture database 490, a mobile device interface 492, and other computer-executable instructions or other data. The computer-executable program code of the network server application 470 or the gesture control application 321 may instruct the processing device 420 to perform certain logic, data-processing, and data-storing functions of the banking system 400 described herein, as well as communication functions of the banking system 400.

In an embodiment, the command gesture database 490 is a database that stores the command gestures and associates an action affecting the transaction with the command gestures. In some embodiments, the processor identifies the command gesture after the positioning system device of the mobile device senses the command gesture. The processor compares the command gesture to gestures stored in the command gesture database 490 and determines the action that will be taken in the transaction. For example, the positioning system device senses when the user turns the mobile device over. The processor identifies that the mobile device has been turned over and compares that gesture to the command gesture database 490. The processor determines that when the transaction reporting functionality (i.e., audible notification of transaction steps) should be muted when the mobile device is turned over. The processor then causes the mobile device and/or the point-of-transaction device to mute.

In an embodiment, the actions associated with gestures in the command gesture database 490 are default gestures. For example, the financial institution, the provider of the computer-implemented method, or the manufacturer of the mobile device may establish default commands associated with different gestures. In a further embodiment, the user customizes the gestures associated with actions in the command gesture database 490. The user may use a graphical user interface in an application or web interface to instruct the computer-implemented method that the user is assigning an action to a gesture. The user may select an action from a list of actions and then perform the gesture that the user would like to associate with the action. For example, the user may select the action “complete the transaction” from a list of possible actions and then perform an action such as moving the mobile device in a figure eight. In doing so, the user has assigned the action “complete the transaction” to the command gesture of making a figure eight with the mobile device. The command gesture database 490 is updated with this relationship for the user.

In some embodiments, the gesture control application 321 in the financial institution banking system is the same application as located on the mobile device. In other embodiments, some functionality is present in the financial institution banking system 400 and some functionality is present in the mobile device. As should be understood, the software and hardware providing the gesture control functionality can be entirely present on the mobile device, entirely present on the financial institution banking system 400, or divided in some manner between the mobile device and the banking system 400.

In further embodiments, the mobile device interface 492 facilitates communication between the mobile device and the banking system. For example, the mobile device interface 492 may establish a connection with the mobile device, may encrypt or decrypt communications with the mobile device, or may provide a portal for the user to interact with the gesture control application 321 on the banking system 400 through the mobile device. For example, the user may establish non-standard gestures for controlling applications.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network 250, such as the mobile device 204, the point-of-transaction device 220 (e.g., a device at a business), and the banking system 400. The processing device 420 is configured to use the network communication interface 410 to transmit and/or receive data and/or commands to and/or from the other devices connected to the network 250.

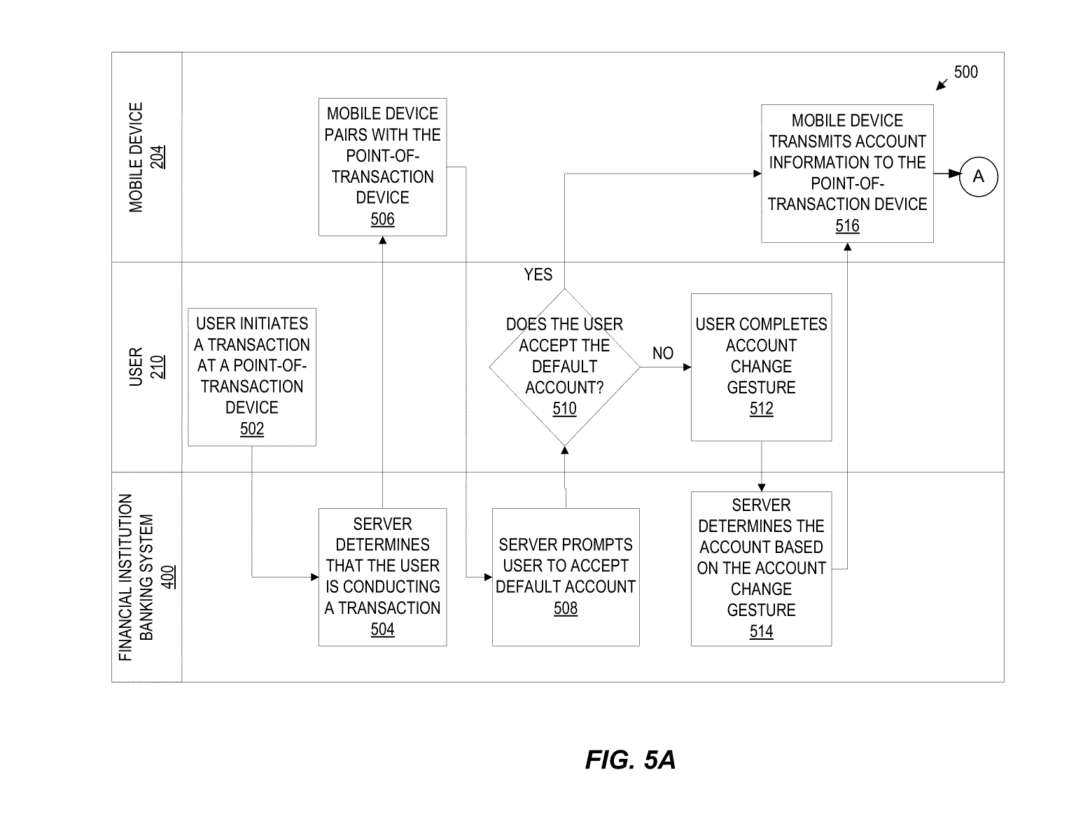

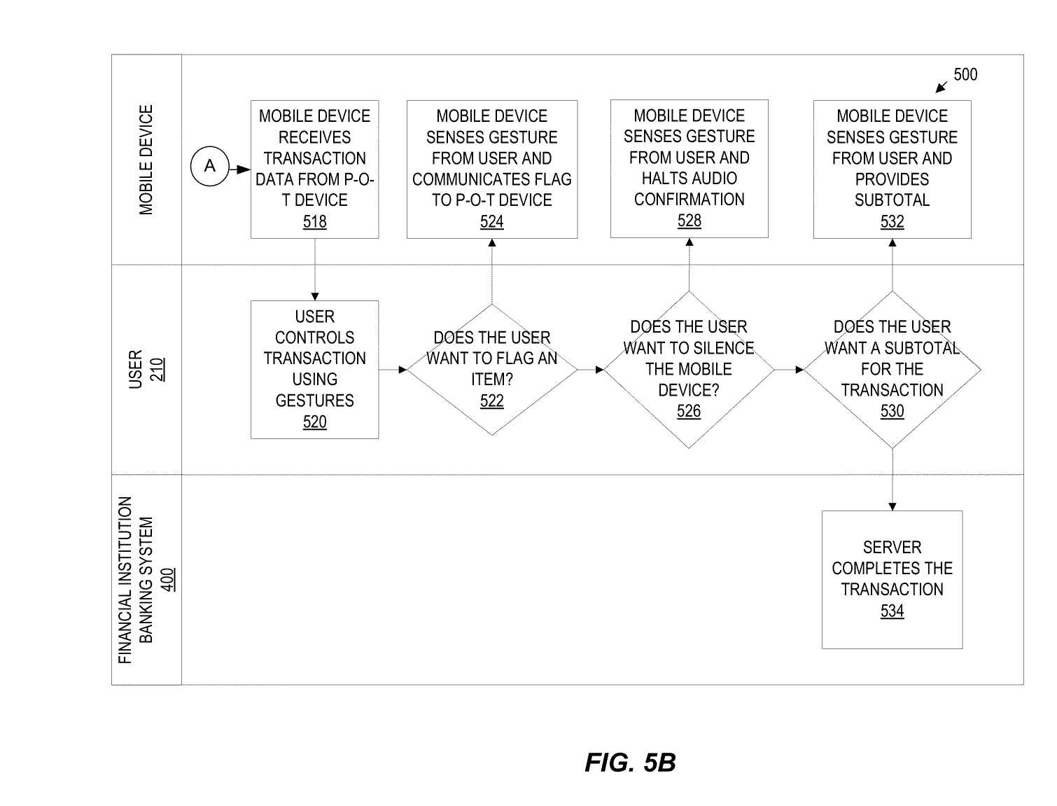

FIGS. 5A and 5B provide a modified flow chart showing actions taken by the user, the mobile device, and the financial institution banking system in a computer-implemented method 500 to control a transaction using command gestures, in accordance with an embodiment of the invention. While the steps are depicted as performed by one of the parties listed in the flow chart, the steps do not need to be performed by that exact party. For example, the server is depicted as determining the user is conducting a transaction in block 504; however, the mobile device may do this instead of or in collaboration with the server.

In block 502, the user, whom in some embodiments has opted-in to the computer-implemented method 500, initiates a transaction at a point-of-transaction device. In an embodiment, the user initiates the transaction using the mobile device. In some embodiments, the user initiates the transaction by activating an application on the mobile device. For example, the user may contact the mobile device with an activating device, such as a dongle on a keychain. In another example, the user selects an application on the mobile device, presses a button, or provides a spoken command to the mobile device. In a still further embodiment, the user initiates the transaction using a gesture, such as a command gesture that indicates the user is initiating a transaction. Command gestures will be discussed in more detail in blocks 520-530. In some embodiments, the user initiates the transaction by syncing the mobile device to the point-of-transaction device.

In some embodiments, the user trains with the mobile device prior to or intermittently between controlling a transaction with command gestures. In one embodiment the user trains with the mobile device on the various command gestures. Training the user on the command gestures increases the accuracy of the computer implemented method. The user may receive audible feedback during practice command gestures. For example, the computer-implemented method may instruct the user to lift the mobile device up more quickly or to turn the mobile device over so that it is parallel to the ground. The computer-implemented method compares the practice command gesture with the reference gesture for a specific action and provides feedback to the user in how to more accurately perform the command gesture. In this manner, the user is trained on the command gestures and the computer-implemented method is better able to identify the command gesture in a transaction situation.

In another embodiment, the user trains with the mobile device so that the mobile device is customized for the user. For example, some users find certain command gestures difficult to complete. The user may be unable to rotate their wrist and therefore prefer not to turn the mobile device over as the default command gesture for silencing the mobile device. Instead, the user may train the device to silence when the user quickly lowers the device. In another example, the user may be able to perform the command gesture but prefers to perform it differently from the default movement. The user may be able to laterally flick the mobile device but may do so more slowly than the reference gesture. By training the device to the user, the mobile device can be calibrated to the user's mobility and allow differently-enabled individuals to control transactions using command gestures. In an embodiment, the user selects an action from a list and then performs the command gesture to either train on the gesture or train the device to the user's mobility. It should be understood that the user may both train on gestures so that the gestures are performed consistently during transactions but also train the mobile device to the user, e.g., calibrate the device to the user's mobility. In this manner, accuracy of the computer-implemented method during transactions is improved while also customizing the computer-implemented method to the user.

In a still further embodiment, the mobile device and the user continue to train and learn during a transaction controlled by command gestures. For example, the user may make a command gesture that the mobile device is unable to identify within a specific confidence level. For example, the user may tilt the mobile device laterally to flag an item during a transaction. If the user tilts the mobile device too slowly or for too short of a distance, the mobile device may identify the shortened tilt but not associate the command gesture with the flagging action. The mobile device may evaluate the gesture and calculate that the shortened tilt is indicating flagging an item within a certain degree of confidence, say 70%, but that the mobile device cannot determine the command gesture with a sufficient degree of confidence, such as 95%, to undertake the action. For example, the user may have moved the mobile device to the side accidentally and not intended to flag an item. In this embodiment, the mobile device may query the user whether the user intended to flag the item, such as by an audible question or a written question displayed on the mobile device. If the user confirms that the user did intend to flag the item, the item is flagged. In a further embodiment, the mobile device learns from the user's command gesture as well. For example, after confirming that the user did intend to flag the item, the mobile device may automatically assign the new gesture to transaction command. In another embodiment, the mobile device may query the user to determine whether the reference command gesture should be modified to the most recently made gesture. Multiple command gestures can cause the same transaction command to occur so the default gesture and the gesture calibrated to the user's actions may both be stored in the database. In this manner, the user is able to train the mobile device to the nuances of the user's specific command gestures. If the user tilts the mobile device more slowly than the default or standard command gesture, this can be recorded and applied in future transactions.

In block 504, the financial institution banking system determines that the user is conducting a transaction. In an embodiment, the user activates an application, such as by pressing a button or contacting an activation device to the mobile device. For example, the user may include an activation device on a key chain and when the user desires to conduct the transaction, the user contacts the activation device to the mobile device. Separating the activation device from the mobile device adds a further level of security so that if the mobile device is lost, a transaction cannot be completed without the activation device. Further, using an activation device allows a user to activate an application on the mobile device without requiring vision. In another embodiment, the user makes a command gesture that indicates to the method that the user is conducting a transaction. In other embodiments, the computer-implemented method 100 determines that the user is conduct a transaction based on communication from a point-of-transaction device. For example, the user may sync the mobile device with the point-of-transaction device, which then communicates that the user is conducting a transaction to the server.

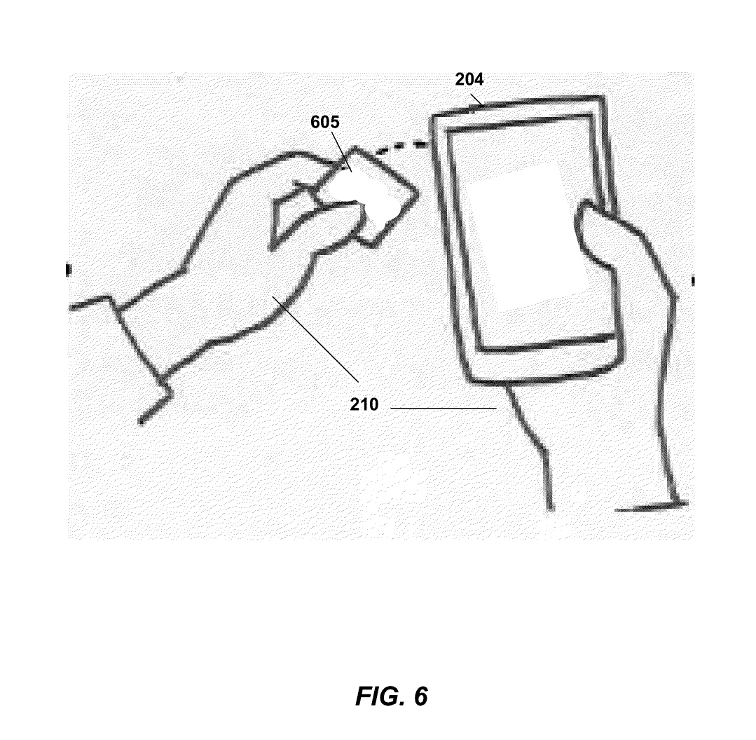

Turning briefly to FIG. 6, an exemplary embodiment of a user 210 activating a mobile device 204 is presented. In the exemplary embodiment, the user 210 contacts or brings an activation device 605 into close proximity to the mobile device 204. The activation device 605 may be configured to require contact between the activation device 605 and the mobile device 204, or the activation device 605 may communicate wirelessly over a small distance. The activation device 605 may be configured in any of a number of form factors. For example, the activation device 605 may be a small chip, a dongle on a keychain, a portion of an identification card, and/or other accessory, such as a wearable accessory. As will be discussed later, the activation device 605 may have multiple capabilities depending on the stage of the transaction at which the activation device 605 contacts the mobile device 204. The activation device 605 may activate the application when initially contacted to the mobile device 204 but may complete the transaction when the application has already been activated.

In block 506 of FIG. 5A, the mobile device pairs with the point-of-transaction device. As discussed, in some embodiments, pairing the mobile device to the point-of-transaction device identifies the mobile device, authenticates the mobile device, and/or syncs the mobile device to allow communication. In an exemplary embodiment, the mobile device displays a barcode on a display screen. The point-of-transaction device scans the barcode and the mobile device and point-of-transaction device are paired. In some embodiments, the mobile device and the point-of-transaction device are paired wirelessly, for example, via Wi-Fi, Near Field Communication devices, or other wireless transmitters. In an embodiment, pairing is accomplished or triggered by a user gesture. For example, the user can move the mobile device towards the point-of-transaction device or tap the point-of-transaction device with the mobile device. In another embodiment, the pairing provides a secure connection, e.g., encrypted, for transmission of financial account data.

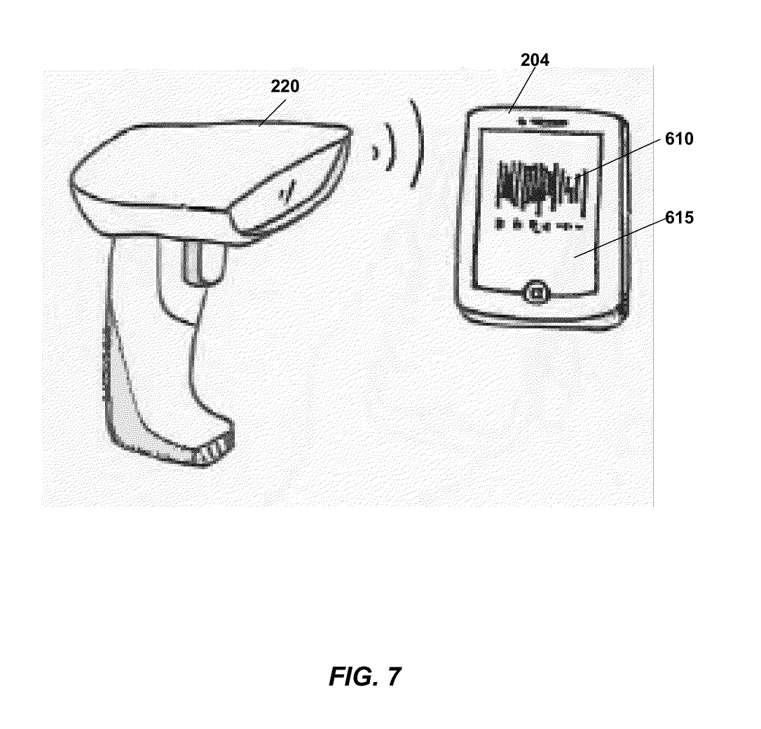

FIG. 7 depicts an exemplary embodiment of the mobile device 204 pairing with the point-of-transaction device 220. As discussed, in some embodiments the mobile device 204 provides a code 610, such as a bar code, that can be scanned by the point-of-transaction device 220. As depicted, the code 610 may be provided on a screen 615 of the mobile device 204.

Pairing the mobile device 204 to the point-of-transaction device 220 allows the user and/or the business to confirm that the command gestures are controlling the proper transaction. For example, if the user attempts to control a transaction but the mobile device is communicating with the incorrect point-of-transaction device, e.g., a different cash register from the register the user is waiting at, then the computer-implemented method would not allow the user to control the transaction based on gestures. In some embodiments, pairing the mobile device to the point-of-transaction device authenticates the identity of the user to the point-of-transaction device. For example, the mobile device may provide the user name to the point-of-transaction device. In another embodiment, authentication is a two part process where the mobile device transmits information to the point-of-transaction device and then the point-of-transaction device, or a person operating the point-of-transaction device, provides a challenge question to the user, which may be related to the transmitted information. For example, the mobile device may wirelessly transmit a Personal Identification Number (PIN) to the point-of-transaction device, e.g., an ATM, during pairing. To authenticate the user's identity, the user must then enter the PIN on a keypad to authenticate his/her identity. In some embodiments, the keypad is displayed on the mobile device so that the symbols, e.g., the alphanumeric symbols, are displayed consistently across multiple transaction platforms.

Turning to block 508 of FIG. 5A, in some embodiments the server prompts the user to accept the default account. The server may require an affirmative action from the user to accept the default account or the server may require an affirmative action from the user to reject the default account. For example, the default account may automatically be used unless the user performs some action after pairing the device. In one embodiment, the mobile device requests the user to select a button on the mobile device to change the default payment method.

In decision block 510, the method determines whether the user accepts the default payment method. If the user accepts the default payment method, the mobile device transmits account information to the point-of-transaction device, as shown in block 516. If the user does not accept the default account, however, the user completes an account change gesture, as shown in block 512. An account change gesture is a command gestures that indicates that the user would like to change the currently selected payment method. In an exemplary embodiment, the account change gesture is a movement of the mobile device, such as lifting the mobile device up and/or forward. In another embodiment, the user cycles through payment methods available to the computer-implemented method by swiping a finger along a screen of the mobile device. As discussed, the user is able to customize the account change gesture.

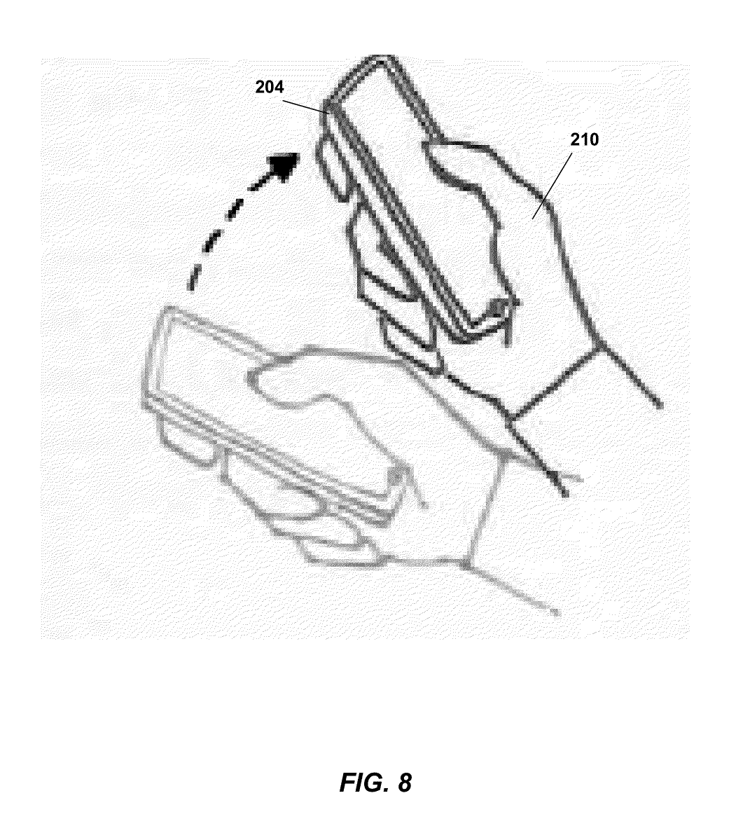

FIG. 8 depicts an exemplary embodiment where the user 210 lifts the mobile device 204 to change the payment method. In an embodiment, the positioning system device (not shown), such as the accelerometer, detects the user's lifting of the mobile device. The processor identifies this action, associates the action with the step of changing the payment method based on, in some embodiments, evaluation of the command gesture database, and allows the user to select a different payment method. In an embodiment, the lifting the mobile device allows the user to cycle through various accounts available to the computer-implemented method.

In block 514 of FIG. 5A, the server determines the account based on the account change gesture. As the user cycles through accounts available to the computer-implemented method, as discussed in block 512, the server determines the account associated with the user's selection. In an embodiment, the server also prompts the mobile device to notify, such as via audible notification, the account currently selected. In this manner, visually-impaired individuals are able to cycle through accounts and select their desired account for use during the transaction.

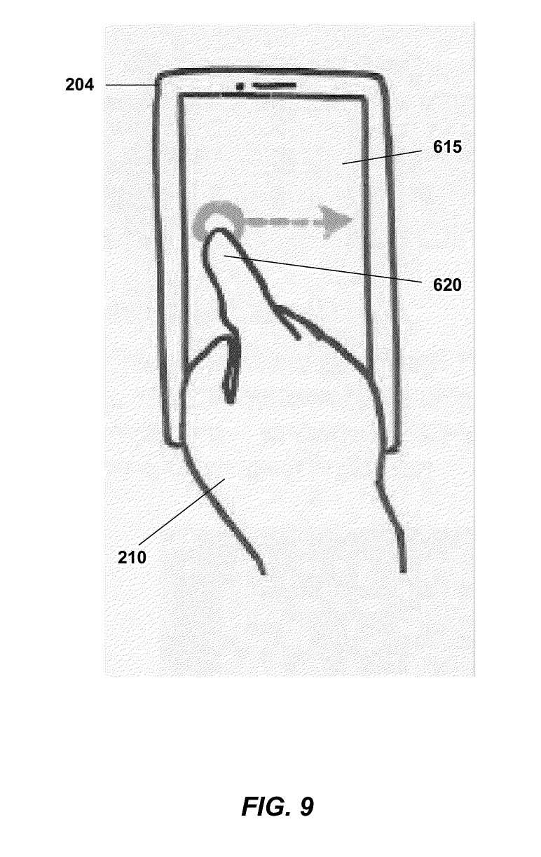

FIG. 9 depicts an exemplary embodiment of the user 210 cycling through accounts by swiping a finger 620 along a touch-sensitive screen 615. As the user 210 moves a finger along the screen 615, the existing account is swiped away and a new account is selected. In a further embodiment, the mobile device 204 provides audible notification of the account that is selected, such as by announcing the name of the account or a nickname provided for the account by the user.

Turning now to block 516 of FIG. 5A, the mobile device transmits account information to the point-of-transaction device. In an embodiment, the mobile device transmits the account information necessary to complete the transaction to the point-of-transaction device. For example, the mobile device may transmit the account number for the selected account to the point-of-transaction device, which then proceeds with the transaction over standard channels. In another embodiment, authorization is initially transmitted to the point-of-transaction device and account numbers or other potentially confidential information is transmitted when the transaction is nearing completion. In some embodiments, the information is transmitted wirelessly, such as via Wi-Fi, NFC, or other wireless transmitter.

In block 518, the mobile device receives transaction data from the point-of-transaction device. In some embodiments, the mobile device receives information regarding the transaction, such as the location, time, or merchant associated with the transaction. The mobile device may also receive details of the transaction such as the items being purchased, the cost of the items, and/or any coupons or discounts related to the items, etc.

In another embodiment (not shown), the mobile device notifies the user of the transaction data received. For example, the mobile device may audibly announce the items that are being scanned in the transaction. If a user is purchasing five items at a store, the mobile device can audibly announce the item and/or the price of the item as the items are scanned. In another embodiment, the computer-implemented method causes the point-of-transaction device to audibly announce the item and/or the price of the item as it is being scanned. In a still further embodiment, the mobile device confirms that the item being scanned is an item that was on a list provided by the user. For example, the user may provide a wish list or shopping list of items. As the item is scanned at the point-of-transaction device, the computer-implemented method determines that the item has been purchased and the item is removed from the list. At the end of the transaction, the computer-implemented method can provide the user with a list of exceptions to the pre-provided list. For example, a list of items that were purchased but not on the list can be provided, or a list of items that were on the list but not purchased can be provided.

In block 520, the user controls the transaction using gestures. In an embodiment, the user manipulates the mobile device in a specific manner to cause a specific action to occur. In an embodiment, the mobile device detects the movement of the mobile device, such as by using the accelerometer, GPS unit, or other positioning system device. The movement is identified and an action associated with the movement is performed during the transaction. In one embodiment, the financial institution determines which movements control which actions in the transaction. The movements may be determined based on the type of mobile device selected. In another embodiment, the user is able to customize the computer-implemented method to associate movements of the mobile device with actions that can be performed during the transaction. Users may desire the ability to customize the computer-implemented method so that movements can be easily remembered or performed. Blocks 522-530 disclose decision blocks and actions that can be controlled by movement of the mobile device. It should be understood that a variety of actions can be controlled during a transaction. The actions disclosed in blocks 522-530 are merely illustrative and not intended to limit the range of actions that can be controlled by command gestures through the computer-implemented method. For example, as discussed previously in blocks 510-514, the user may desire to change the payment method during the transaction. In some embodiments, the user may do so by controlling the transaction with command gestures.

Turning now to decision block 522, the user may desire to flag an item during a transaction. Flagging an item indicates to the user and/or to a person operating the point-of-transaction device that the user has a question about the item. For example, the user may question the price of the item. The mobile device provides audible notification of the price of the items being scanned at the point-of-transaction device and the user may question the price of one of the items. The user can flag this item so that at the end of the transaction, the person operating the point-of-transaction device is notified of the user's concern and prompted to resolve the issue. In a similar example, the user may desire more of a certain item, may desire a rebate associated with a specific item, or may have a question (e.g., the color of an item, the contents of an item, etc.) regarding the item.

The user can perform a command gesture using the mobile device to flag an item as the transaction is being conducted at the point-of-transaction device, as shown in block 524. For example, the user may laterally tilt the mobile device to flag an item. In another embodiment, performing a gesture with the mobile device comprises tapping a touch-sensitive surface of the mobile device. The user may tap the touch-sensitive screen after an item is scanned to flag the item. After the user flags the item, the mobile device communicates the flag to the point-of-transaction device. In this manner, the point-of-transaction device is able to notify the operator immediately or at the end of the transaction. As discussed previously, flagging an item can be done for different reasons. Different gestures can be used to indicate the different reasons. For example, the user can laterally tilt the mobile device to flag an item for a price discrepancy but can tap the surface of the mobile device to flag an item for more information.

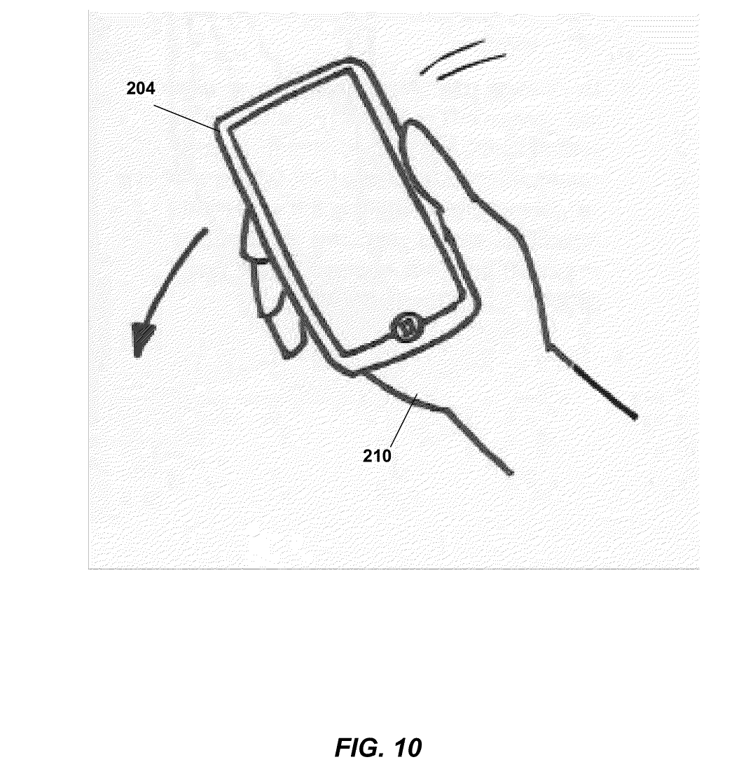

FIG. 10 depicts an exemplary embodiment where the user 210 is laterally tilting the mobile device 204 to flag an item. As discussed, during the transaction the user may have a question regarding an item being scanned during the transaction but does not wish to raise the question immediately. Instead, the user 210 can flag the item for later review by the merchant or the user. In some embodiments, an audible notification of the item and/or the price is provided to the user when the item is scanned. If the user has a question about the item, the user can quickly and easily flag the item by tilting the mobile device.

In decision block 526 of FIG. 5B, the user may desire to silence the mobile device and/or the point-of-transaction device. For example, the user may not desire audible notification of the items being scanned during the transaction. At any point during the transaction, the user may silence the mobile device and/or the point-of-transaction device by performing a gesture with the mobile device, as shown in block 528. In an exemplary embodiment, the user inverts the mobile device (i.e., turns the mobile device over) to silence the mobile device. The user may reverse the gesture to resume audible notification of the transaction. In a further embodiment, the user can modify the audible notification with command gestures. For example, the user can speed up or slow down the recitation of the items being scanned. The user may do so by lifting or lowering the mobile device. The user may also make the audible notification louder or quieter using gestures, such as by selecting a button on the mobile device. In one embodiment, changing the volume control on the mobile device, e.g., depressing a button on the side of the mobile device, controls the volume of the point-of-transaction device. Still further, the user can cause the mobile device or the point-of-transaction device to repeat a previous audible notification using gestures. In an embodiment, a single gesture can cause different actions to occur during the transaction based on context. For example, if the user is changing the payment method and swipes a finger across the mobile device screen, the user may cycle through the various payment methods. If, however, the user is not in the change payment method mode, i.e., has not lifted the mobile device upwards, swiping a finger across the mobile device screen may alter the transaction in a different manner. For example, swiping a finger across the mobile device screen may cause the computer-implemented method to repeat the previous audible notification or cycle through the items scanned in the transaction.

Turning now to decision block 530, the user may also want a subtotal for the transaction. In an embodiment, the user may be able to make a specific gesture, e.g., shaking the mobile device, that prompts the mobile device and/or the point-of-transaction device to provide an audible notification of the current subtotal for the transaction. The mobile device detects the gesture, as shown in block 532, and provides the subtotal. In an embodiment, the mobile device provides an audible notification; in another embodiment, the mobile device causes the point-of-transaction device to provide the audible notification. In another embodiment, a written notification is provided, such as on a screen of the mobile device. In a still further embodiment, the computer-implemented method provides alternative information regarding the status of the transaction. For example, the computer-implemented method can notify the user of the number of items in the transaction, the percentage of items from a pre-defined list that have been scanned, or the amount remaining in the account after the cost of the currently scanned items have cleared the account.

Turning now to block 534, the server completes the transaction. As the transaction nears completion, which may differ based on the types of transaction (e.g., the last item is scanned, the user completes a return, the ATM indicates that the last action has been taken, etc.), the user can cause the server to complete the transaction. In an embodiment, the user completes the transaction based on gestures. In an exemplary embodiment, the user contacts the activation device to the mobile device to authorize the transaction. FIG. 6 discloses the user contacting the activation device to the mobile device to activate the application; as discussed herein, the same action (i.e., contacting the activation device to the mobile device) completes the transaction. In another embodiment, the server completes the transaction after detecting an interaction between the mobile device and the point-of-transaction device. For example, the user may tap the mobile device against a receiver, such as a Near Field Communication device, at the point-of-transaction to complete the transaction.

In another embodiment, the user is prompted to enter a personal identification number on a keypad associated with the mobile device. For example, the keypad may be an alphanumeric keypad that is used for dialing or the keypad may be a keypad displayed on the mobile device screen. By providing the keypad on the mobile device, the computer-implemented method assists users because the keypad can be kept consistent across a wide range of point-of-transaction devices. The user knows where the keypad is located, the layout of the keys, and is able to confidently enter the PIN on the keypad. Once the user has authorized the transaction, such as by using the keypad or by tapping the device to the point-of-transaction device, the computer-implemented method completes the transaction. In an embodiment, the funds are transferred between the selected account and the point-of-transaction account. In a still further embodiment, an audible notification is provided to the user when the transaction is completed. The audible notification may indicate to the user that the connection between the mobile device and the point-of-transaction device has been disconnected. The computer-implemented method may also send, such as via email, a receipt of the items purchased in the transaction to the user. The receipt can be reviewed later for accuracy. In an embodiment, the computer-implemented method can audibly notify the user of the items in the receipt at a later time or date.

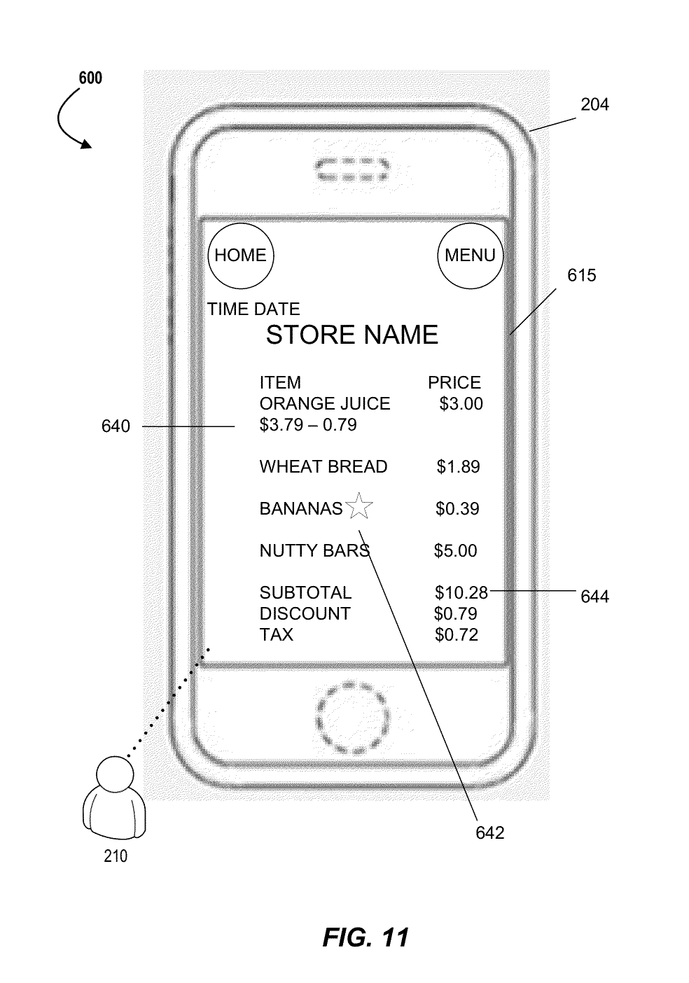

In FIG. 11, an example of a method of providing a receipt to the user is presented, in accordance with an embodiment of the invention. In this example, the user 210 receives a receipt 640 of the transaction on the user's mobile device 204. The receipt 640 is displayed on the screen 615 in response to the user 210 controlling a transaction using gestures at a point-of-transaction device. Advantageously, the receipt 640 is able to immediately read back the items purchased by the user or read back the items at a later time. In an embodiment, the receipt 640 indicates items that have been flagged 642 for further review using a gesture. The receipt 640 also indicates the subtotal 644 or total for the transaction. Other information relating to the transaction can also be shown in the receipt 640. For example, the store name and the costs of items can also be displayed. In an embodiment, the mobile device 204 includes a screen 615 that allows the user to enter the PIN associated with the account when completing the transaction. While not externally visible on the example mobile device, the mobile device 204 also includes positioning system devices, such as GPS units, accelerometers, and/or other position sensing devices, that allow the user 210 to control the transaction using command gestures, as disclosed herein.

The above description refers to a processor in a mobile device as the computing device processor and describes the mobile device as performing the computer-implemented method. It should be understood, however, that the computing device processor can be a remote server and the processor associated with the remote server can perform the computer-implemented method. In one embodiment, the data processing associated with the computer-implemented method can be performed on the mobile device and the data can be stored on remote servers. In another embodiment, the data is stored on the mobile device. For example, the user's account information may be intermittently or regularly uploaded to a secure database on the user's mobile device and accessed when the computer-implemented method is activated on the user's mobile device. In this example, the computer-implemented method is capable of operating when the user does not have access to wireless networks, such as in areas of low coverage or where buildings prevent coverage.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wired, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments of the invention, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment of the invention, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment of the invention, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1. A computer-implemented method of controlling a transaction based on command gestures, the method comprising:
determining, via a computing device processor, that a user is conducting a financial transaction using a mobile device;
sensing, via a positioning system device selected from the group consisting of an accelerometer, a GPS receiver, a magnetometer, an altimeter, a compass, and a Wi-Fi receiver, at least one command gesture performed by the user with the mobile device;
altering at least one aspect of the transaction based on the command gesture;
determining, via a computing device processor, that the mobile device has been physically contacted to an activation device separate from the mobile device; and
authorizing the transaction based on the physical contact between the activation device and the mobile device.

2. (canceled)

3. (canceled)

4. The computer-implemented method of claim 1 further comprises:
storing one or more reference gestures in a storage device, wherein each gesture is associated with a function to be performed as an aspect of the transaction; and
comparing a sensed command gesture to the one or more reference gestures in the storage device to determine the aspect of the transaction to be altered.

5. The computer-implemented method of claim 1, wherein altering at least one aspect of the transaction comprises entering a payment mode based on a command gesture.

6. The computer-implemented method of claim 1, wherein altering at least one aspect of the transaction comprises changing a payment method for the transaction based on a command gesture.

7. The computer-implemented method of claim 1, wherein altering at least one aspect of the transaction comprises providing a subtotal for the transaction based on a command gesture.

8. The computer-implemented method of claim 1, further comprising:
providing an audible notification of the transaction; and
muting the audible notification based on a command gesture.

9. The computer-implemented method of claim 1, wherein altering at least one aspect of the transaction comprises flagging an item associated with the transaction based on a command gesture.

10. The computer-implemented method of claim 9, further comprising transmitting a notification to the point-of-transaction device when an item associated with the transaction is flagged.

11. The computer-implemented method of claim 1, further comprising storing customizable command gestures.

12. The computer-implemented method of claim 1, further comprising providing audible notification of the initiation and completion of the transaction.

13. The computer-implemented method of claim 1, further comprising pairing the mobile device to the point-of-transaction device.

14. The computer-implemented method of claim 13, wherein pairing the mobile device to the point-of-transaction device comprises providing a code on the mobile device that is scannable by the point-of-transaction device.

15. The computer-implemented method of claim 1, further comprising initiating completion of the transaction upon receiving a command gesture.

16. The computer-implemented method of claim 1, further comprising initiating completion of the transaction upon receiving a personal identification number entered by the user into a keypad associated with the mobile device.

17. A device for controlling a transaction based on command gestures, the device comprising:
a mobile device comprising a positioning system device selected from the group consisting of an accelerometer, a GPS receiver, a magnetometer, an altimeter, a compass, and a Wi-Fi receiver;
an activation device separate from the mobile device;
a computing platform including a processor and a memory, wherein the computing platform is operably linked to the mobile device;
a transaction identification routine stored in the memory, executable by the processor, and configured to determine that a user is conducting a transaction using a mobile device;
a sensing routine stored in the memory, executable by the processor, and configured to sense at least one command gesture performed by the user with the mobile device;
an activation routine stored in the memory, executable by the processor, and configured to determine that the mobile device has been physically contacted to the activation device;
a transaction routine stored in the memory, executable by the processor, and configured to alter at least one aspect of the transaction based on the command gesture; and
an authorization routine stored in the memory, executable by the processor, and configured to authorize the transaction based on the physical contact between the activation device and the mobile device.

18. (canceled)

19. (canceled)

20. The device of claim 17, wherein the mobile device comprises a communication device, wherein the communication device is configured to communicate with the point-of-transaction device.

21. (canceled)

22. The device of claim 17, wherein the mobile device comprises a keypad, wherein the keypad is configured to receive a personal identification number from the user for completing the transaction.

23. The device of claim 17, wherein the device further comprises a notification routine stored in the memory, executable by the processor, and configured to notify the user of the status of the transaction.

24. The device of claim 17, wherein the device further comprises a completion routine stored in the memory, executable by the processor and configured to complete the transaction after receiving a command gesture from the user.

25. A computer program product for controlling a transaction based on command gestures, the computer program product comprising:
a non-transitory computer-readable medium comprising:
a set of codes for causing a computer to determine that a user is conducting a transaction using a mobile device;
a set of codes for causing a computer to sense at least one command gesture performed by the user with the mobile device, wherein the mobile device comprises a positioning system device selected from the group consisting of an accelerometer, a GPS receiver, a magnetometer, an altimeter, a compass, and a Wi-Fi receiver;
a set of codes for causing a computer to determine that the mobile device has been physically contacted to an activation device separate from the mobile device;
a set of codes for causing a computer to alter at least one aspect of the transaction based on the command gesture; and
a set of codes for causing a computer to authorize the transaction based on the physical contact between the activation device and the mobile device.

26. The computer program product of claim 25, wherein the set of codes determines that the user is conducting a transaction based on a command gesture.

27. The computer program product of claim 25, wherein the set of codes senses the command gesture using a positioning system device.

28. The computer program product of claim 25, wherein the set of codes alters at least one aspect of the transaction by sensing the command gesture and comparing the sensed command gesture to a database comprising a plurality of command gestures and associated transaction commands.

29. The computer program product of claim 25, further comprising a set of codes for causing a computer to receive a pre-defined list for the transaction, and a set of codes for causing a computer to compare the pre-defined list to the transaction.

30. The computer program product of claim 25, wherein a subtotal for the transaction is provided by the user shaking the mobile device.

31. The computer program product of claim 25, wherein the transaction is silenced by turning the mobile device over.

32. The computer program product of claim 25, wherein an item in the transaction is flagged by laterally tapping the mobile device.

33. A mobile system for controlling a transaction based on command gestures, the device comprising:
a mobile device;
a storage device comprising one or more command gestures and at least one function associated with the command gesture;
an activation device separate from the mobile device;
a positioning system device selected from the group consisting of an accelerometer, a GPS receiver, a magnetometer, an altimeter, a compass, and a Wi-Fi receiver configured to sense a command gesture input by a user by movement of the mobile device;
a computer processor in communication with said storage device and said positioning system device, wherein said computer processor is configured to:
perform a transaction between the mobile device and a point-of-transaction device;
receive a command gesture sensed by said positioning system device;
determine from said storage device a function associated with the command gesture sensed by said positioning system device;
alter the transaction based on the function;
determine that the mobile device has been physically contacted to the activation device; and
authorize the transaction based on the physical contact between the activation device and the mobile device.
